(19) United States
(12) Patent Application Publication
(10) Pub. No.: US 2009/0262180 A1
(43) Pub. Date: Oct. 22, 2009

(54) APPARATUS FOR GENERATING PANORAMIC IMAGES AND METHOD THEREOF

(75) Inventors: Geon-ho KIM, Suwon-si (KR); Bom-jun KWON, Seoul (KR); Tai-ho CHOI, Suwon-si (KR); Hee-jin CHUNG, Seoul (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/350,417

(22) Filed: Jan. 8, 2009

(30) Foreign Application Priority Data
Apr. 18, 2008 (KR) 2008-36115

(51) Int. Cl. H04N 5/232

(52) U.S. Cl. 348/36; 348/E05.042

(57) ABSTRACT

A panoramic image generating apparatus, including a plurality of sub processors; and a main processor to divide data of an image to be processed to form a panoramic image into a plurality of areas, assign the divided data to a plurality of sub processors, and process the data in parallel. Accordingly, the time required to generate a panoramic image is reduced.

### CROSS-REFERENCE TO RELATED APPLICATIONS

This application claims the benefit of Korean Patent Application No. 2008-36115, filed in the Korean Intellectual Property Office on Apr. 18, 2008, the disclosure of which is incorporated herein by reference.

### BACKGROUND OF THE INVENTION

1. Field of the Invention

Aspects of the present invention relate to a panoramic image generating apparatus and a method thereof, and more particularly, to a panoramic image generating apparatus for processing a plurality of processes in parallel for each of a plurality of sub processors of a panoramic image processor, and a method thereof.

2. Description of the Related Art

With a conventional photographing apparatus, a wide angle image cannot fit into a single image frame. Therefore, a user may need to photograph a plurality of still images and then assemble the photographed images to form a wide image. This is referred to as panoramic photography.

Recently, digital cameras and digital camcorders have a function to generate panoramic images. Conventional panoramic photography generates a panoramic image by extracting key points from a plurality of source images, matching the extracted points, stitching the plurality of source images using the matched key points, and blending the stitched source images. However, as the process of generating a panoramic image is sequentially performed for a plurality of source images, the amount of data to be processed increases, and thus much time is required.

### SUMMARY OF THE INVENTION

Aspects of the present invention relate to a panoramic image generating apparatus and a method thereof, in which a plurality of processors perform, in parallel, a plurality of operations of a process for processing a panoramic image, and thus the time required to generate a panoramic image is reduced.

According to an aspect of the present invention, a method of generating a panoramic image is provided. The method includes dividing data of an image to be processed to form the panoramic image into a plurality of areas; assigning the divided data to a plurality of sub processors, and processing the data in parallel; and combining the data processed by the sub processors so as to form the panoramic image. According to another aspect of the present invention, the dividing of the data, the assigning and processing of the divided data, and the combining of the data may be performed by each of a plurality of sub processors of a panoramic image process.

According to another aspect of the present invention, the sub processors perform one of a first operation to extract key points from a plurality of source images, a second operation to match the extracted key points, a third operation to stitch the plurality of images using the matched key points, and a fourth operation to blend the stitched source images.

According to another aspect of the present invention, the first operation includes dividing the source image into a plurality of areas; assigning the divided source images to the plurality of sub processors, and blurring the source images; dividing the blurred source images into a plurality of areas; assigning the divided source images to the plurality of sub processors, and calculating the difference of Gaussians; and extracting the key points using the calculated difference of Gaussians.

According to another aspect of the present invention, the second operation includes building a search tree to search for and match the key points; assigning the search tree to the plurality of sub processors, and traversing each branch unit of the search tree; and matching the key points by traversing the search tree.

According to another aspect of the present invention, the third operation includes dividing the source image into a plurality of areas; assigning the areas corresponding to the key points to the plurality of sub processors and extracting source coordinates corresponding to target coordinates on the panoramic image to be generated; applying a source image corresponding to the extracted source coordinates to the target coordinates, and dividing the source image; assigning the divided source image to the plurality of sub processors, and interpolating the source image; and generating the source image stitched by the interpolation.

According to another aspect of the present invention, the fourth operation includes dividing the stitched source image into lines; assigning starting addresses of the lines to the plurality of sub processors, and reducing or enlarging the stitched source image; combining the reduced or enlarged source image, and generating a panoramic image.

According to another aspect of the present invention, the divided data is assigned using round-robin scheduling.

According to another aspect of the present invention, a panoramic image generating apparatus is provided. The apparatus includes a plurality of sub processors; and a main processor to divide data of an image to be processed to form the panoramic image into a plurality of areas, to assign the divided data to the plurality of sub processors, and to process the data in parallel.

According to another aspect of the present invention, the main processor divides the data and assigns the data for each of at least one operation of a panoramic image process.

According to another aspect of the present invention, the at least one operation comprise at least one of a first operation to extract key points from a plurality of source images, a second operation to match the extracted key points, a third operation to stitch the plurality of images using the matched key points, and/or a fourth operation to blend the stitched source images.

According to another aspect of the present invention, during the first operation, the plurality of sub processors blur the source images; the main processor divides the blurred source images into a plurality of areas and assigns the divided source images to the plurality of sub processors; and the plurality of sub processors calculate the difference of Gaussians and extract the key points using the calculated difference of Gaussians.

According to another aspect of the present invention, during the second operation, the main processor builds a search tree to search for and match the key points and assigns the built search tree to the plurality of sub processors; and the plurality of sub processors traverse each branch unit of the search tree and match the key points.

According to another aspect of the present invention, during the third operation, the main processor divides the source image into a plurality of areas, and assigns the areas corresponding to the key points to the plurality of sub processors, the plurality of sub processors extract source coordinates corresponding to target coordinates on a panoramic image to be generated; the main processor applies a source image corresponding to the extracted source coordinates to the target coordinates, divides the source image, and assigns the divided source image to the plurality of sub processors; and the plurality of sub processors interpolate the source image and generate the source image stitched by the interpolation.

According to another aspect of the present invention, during the fourth operation, the main processor divides the stitched source image into lines and assigns starting addresses of the lines to the plurality of sub processors; the plurality of sub processors reduce or enlarge the stitched source image; and the main processor combines the reduced or enlarged source image to generate the panoramic image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 illustrates a panoramic image generating apparatus according to an embodiment of the present invention;

FIGS. 2A to 5 illustrate a process of generating a panoramic image according to an embodiment of the present invention;

FIGS. 6A and 6B illustrate a process of matching key points according to an embodiment of the present invention;

FIGS. 7 and 8 illustrate a process of stitching data according to an embodiment of the present invention; and

FIG. 9 is a flowchart of a process of generating a panoramic image according to an embodiment of the present invention;

FIG. 10 is a flowchart of a process of calculating a key point according to an embodiment of the present invention;

FIG. 11 is a flowchart of a process of matching key points according to an embodiment of the present invention;

FIG. 12 is a flowchart of a process of stitching data according to an embodiment of the present invention; and

FIG. 13 is a flowchart of a process of blending images according to an embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to like elements throughout. The embodiments are described below, in order to explain the present invention by referring to the figures.

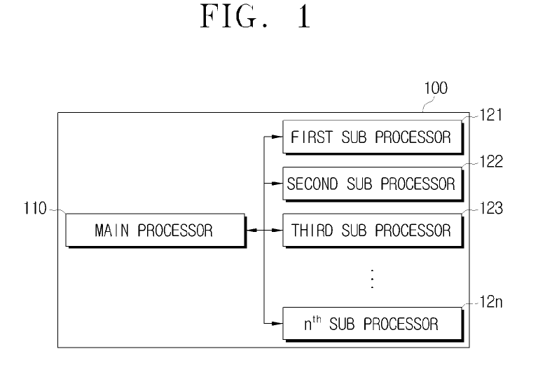

FIG. 1 shows a panoramic image generating apparatus 100 according to an exemplary embodiment of the present invention. The panoramic image generating apparatus 100 may include a main processor 110, and a plurality of sub processors 121 to 12n. According to other aspects of the present invention, the panoramic image generating apparatus 100 may include additional and/or different units. The panoramic image generating apparatus may be included in, for example, a digital camera, camcorder, mobile phone, personal digital assistant, computer, or personal entertainment device.

The main processor 110 divides data of an image to be processed as a panoramic image into a plurality of areas, and assigns the divided data to the sub processors 121 to 12n so that the sub processors may process the assigned data in parallel. The main processor 110 divides the data and assigns the divided data to the respective sub processors for panoramic image processing. The operation of assigning the data may use round-robin scheduling.

The operations of the sub processors may include at least one of a first operation to extract key points from a plurality of images, a second operation to match the extracted key points, a third operation to stitch the plurality of images using the matched key points, and/or a fourth operation to blend the stitched images. Each sub processor may perform one or more of the operations; thus, for example, the sub processor 121 may perform the first and second operation, and the sub processor 122 may perform the third and fourth operation.

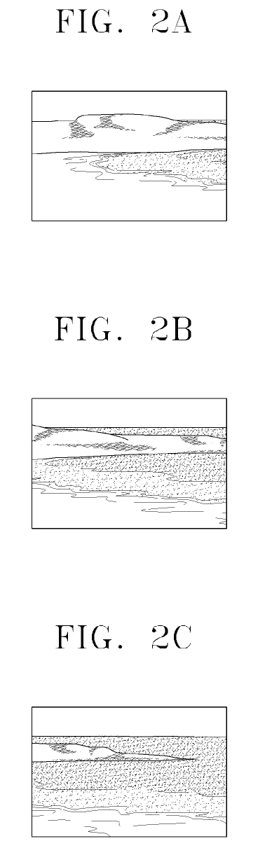

The data may be transmitted or received between the main processor 110 and the sub processors 121 to 12n using a double buffering technique. The sub processors 121 to 12n may use the Single Instruction, Multiple Data (SIMD) technique to process data. The operations of the main processor 110 and sub processors 121 to 12n will be explained in detail with reference to FIGS. 2A to 8.

FIGS. 2A to 5 illustrate a process of generating a panoramic image according to an embodiment of the present invention. FIGS. 2A to 2C show source images to be processed as a panoramic image. The main processor 110 assigns the source image to each of the plurality of sub processors 121 to 12n, respectively, and performs the first operation.

If a source image is input, the main processor 110 divides the source image into a plurality of areas, and assigns each of the areas to a respective sub processors 121 to 12n. The divided source images are assigned to the sub processors 121 to 12n using round-robin scheduling or other scheduling technique. The sub processors 121 to 12n blur the assigned source images, and transmit the blurred images to the main processor 110.

The main processor 110 combines each of the source images blurred by the sub processors 121 to 12n, divides the combined image into a plurality of areas, and assigns the areas to the respective sub processors 121 to 12n. The sub processors 121 to 12n extract key points from the images by calculating the difference of Gaussians.

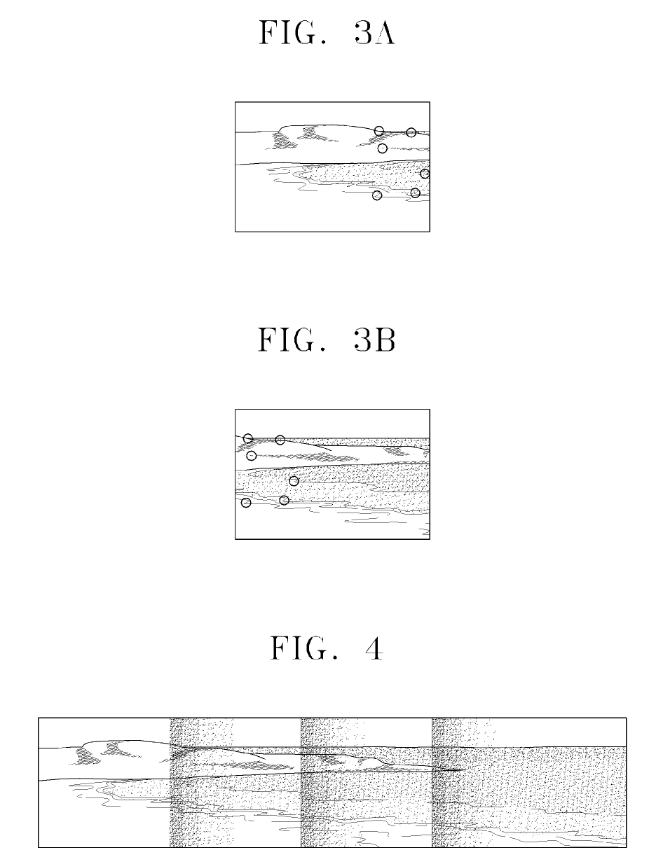

FIGS. 3A and 3B indicate key points of the source images of FIGS. 2A and 2B. When the first operation is completed, the main processor 110 builds a search tree for key points using intervals between the calculated key points. The main processor 110 builds a search tree for key points of source images so as to determine whether a specific key point of the first source image matches a specific key point of another source image by comparing the key points. The main processor 110 assigns the search trees to the sub processors 121 to 12n.

The main processor 110 provides search information for a branch unit of a search tree in order to traverse the search trees assigned to the sub processors 121 to 12n. The search information may include information regarding the structure of a tree and information regarding the key points of nodes constituting a tree.

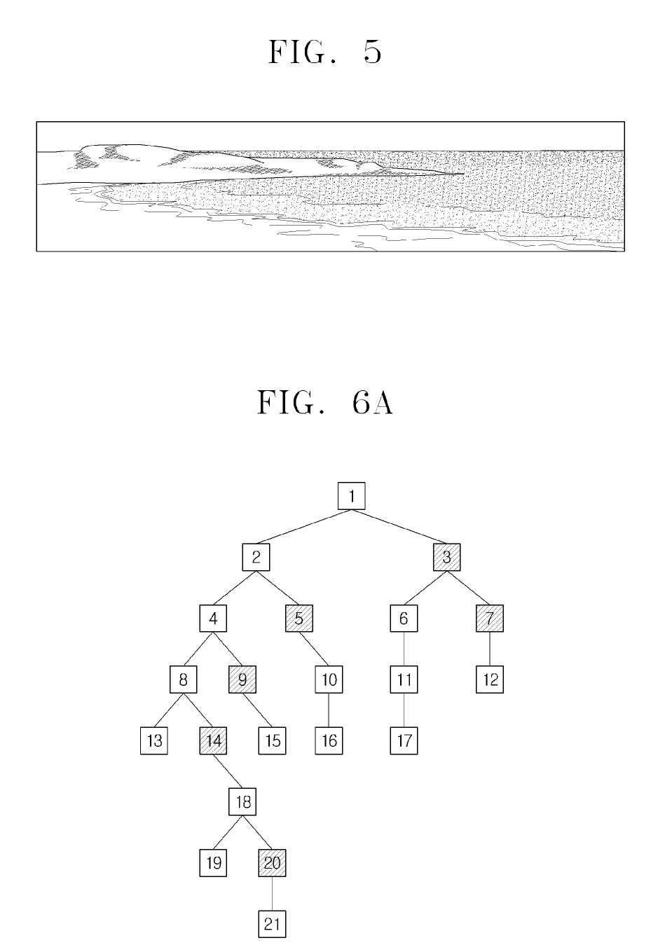

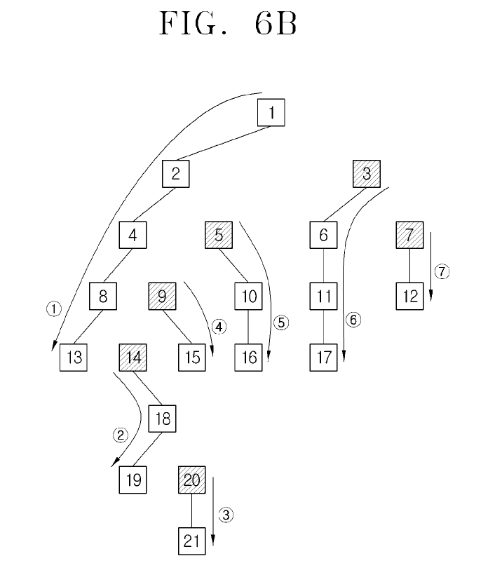

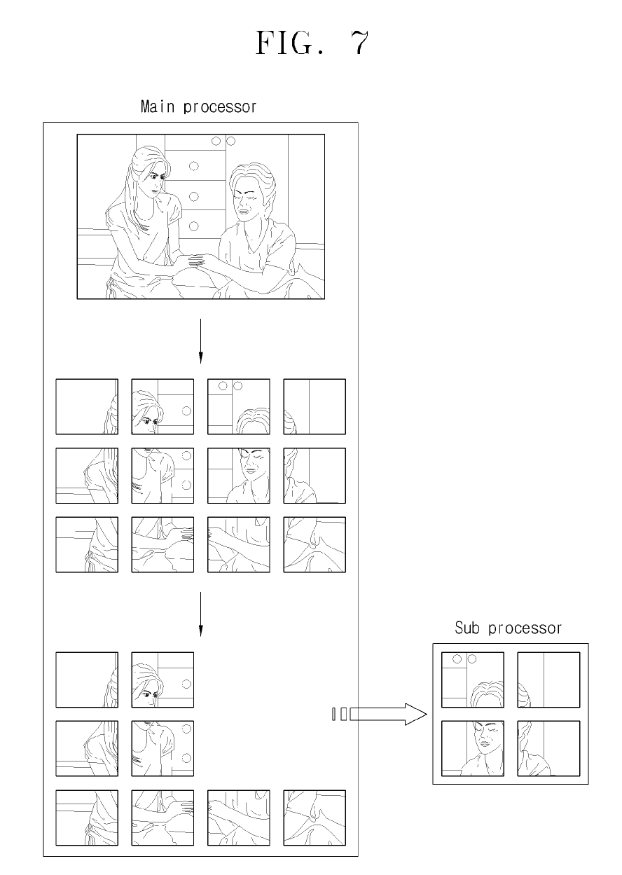

The sub processors 121 to 12n store the search information for a branch unit of a search tree, so memory allocation is reduced. The plurality of sub processors 121 to 12n traverse the assigned tree, and match the key points. Matching key points is performed by calculating key points having the same pixel values among objects of the source images. Detailed description thereof will be given below with reference to FIGS. 6A and 6B.

FIGS. 6A and 6B illustrate a process of matching key points according to an embodiment of the present invention. The tree of FIG. 6A is structured in a form in which a search tree is assigned to the respective sub processors 121 to 12n, and the tree of FIG. 6B represents the operation of the sub processor that traverses the assigned search tree for a branch unit.

The sub processors 121 to 12n scan the respective search trees, match key points, calculate coordinates of the key points, and provide the main processor 110 with the calculated coordinates. The main processor 110 causes the plurality of sub processors 121 to 12n to perform the third operation using the coordinates of key points and the matched key points. The main processor 110 divides the source images of FIG. 2A to 2C into areas of predetermined dimensions, and assigns the areas required to stitch the image to the plurality of sub processors 121 to 12n.

The main processor 110 provides the sub processors 121 to 12n with information used to stitch the image (such as coordinates of key points and the matched key points), and calculates source coordinates corresponding to target coordinates. The target coordinates represent coordinates on which the source image will be positioned, and the source coordinates represent coordinates of the source image.

The main processor 110 receives the calculated source coordinates from the plurality of sub processors 121 to 12n, and disposes the source image on areas of a panoramic image. As the source image may be distorted due to the coordinate conversion, the main processor 110 may interpolate the source image as needed to correct the distortion.

The main processor 110 divides the source image disposed on the panoramic image into a plurality of areas, and provides the sub processors 121 to 12n with the divided images. The interpolation is performed using pixels adjacent to the pixels to be interpolated. The main processor 110 provides the sub processors 121 to 12n with pixel values of minimum areas which do not overlap in order to interpolate the image.

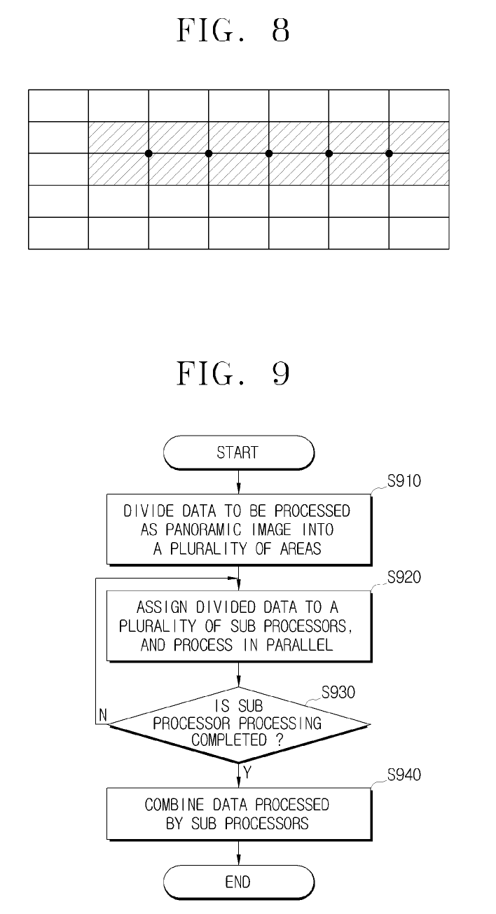

The main processor 110 receives the interpolated source images from the plurality of sub processors 121 to 12n, and generates a stitched source image as shown in FIG. 4. FIGS. 7 and 8 show a process of stitching data according to an exemplary embodiment of the present invention. FIG. 7 shows the operation in which a main processor divides a source image into a plurality of areas and assigns areas to be stitched to sub processors. While part of a source image is provided to a processor, respective source images to be generated as a panoramic image may be provided to a plurality of sub images. The sub processors change the coordinates of the plurality of sub images.

FIG. 8 relates to the interpolation performed after changing coordinates of FIG. 7, in which the main processor 110 provides the sub processors 121 to 12n with five pixels, which may be the minimum number of pixels. The time spent processing overlapped pixels is reduced. The main processor 110 divides the stitched source image into lines, assigns starting addresses for each of the lines to the plurality of sub processors 121 to 12n, and controls the sub processors 121 to 12n to perform the fourth operation. The number of lines may be variably assigned according to the number of sub processors.

The plurality of sub processors 121 to 12n access the starting address of the line assigned by the main processor 110, acquire information regarding pixels of the corresponding line, and enlarge or reduce the image. The main processor 110 generates a panoramic image of FIG. 5 by receiving pixels of the enlarged or reduced image for each of the lines from the plurality of sub processors 121 to 12n, and combining the pixels.

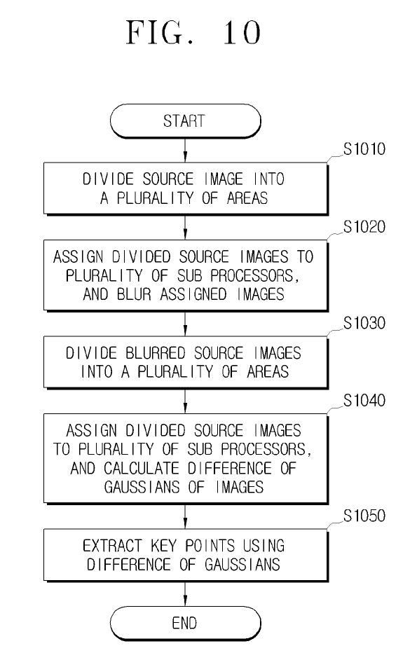

FIG. 9 is a flowchart of a process of generating a panoramic image according to an exemplary embodiment of the present invention. Data to be processed as a panoramic image are divided into a plurality of areas in operation S910, and the divided data are assigned to a plurality of sub processors and processed in parallel in operation S920. The data may be assigned by round-robin scheduling. If the data assigned to the sub processors are completely processed in operation S930, the data processed by the sub processors are combined and output in operation S940.

Operations S910 and S930 may be performed for each of the sub processors of a panoramic image processor. The operations of the sub processors may include a first operation to extract key points from a plurality of images, a second operation to match the extracted key points, a third operation to stitch the plurality of images using the matched key points, and a fourth operation to blend the stitched images.

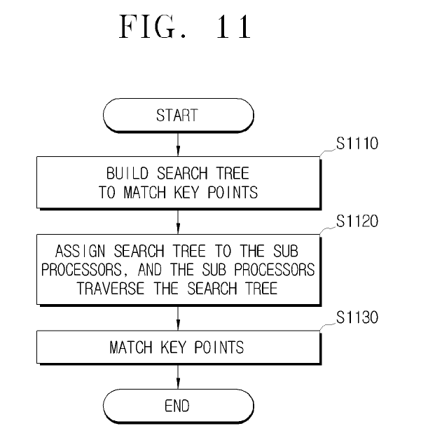

FIG. 10 is a flowchart of a process of calculating key points according to an embodiment of the present invention. FIG. 10 shows the first operation of the plurality of sub processors. A source image is divided into a plurality of areas in operation S1010, the divided source images are assigned to the plurality of sub processors, and the assigned images are blurred in operation S1020.

The blurred source images are divided into a plurality of areas in operation S1030. The divided source images are assigned to the plurality of sub processors, and the difference of Gaussians of the images is calculated in operation S1040. Key points are extracted using the difference of Gaussians in operation S1050.

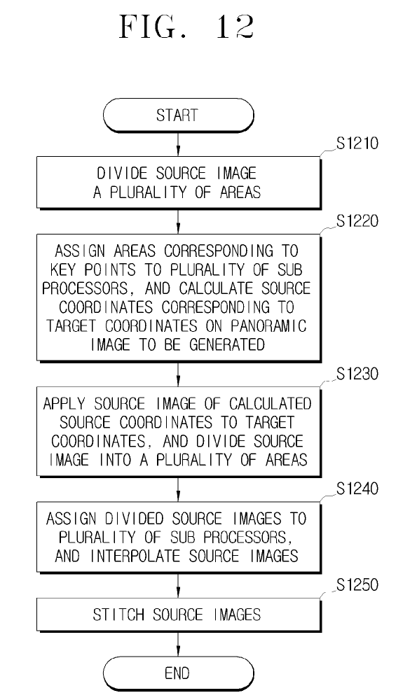

FIG. 11 is a flowchart of a process of matching key points according to an embodiment of the present invention. FIG. 11 shows the second operation of the sub processors, which may be performed after performing operation S1050. A search tree is built to match the key points in operation S1110. The search tree is assigned to the plurality of sub processors, the sub processors traverse the search tree in operation S1120, and the key points are matched in operation S1130. The search tree of each of the sub processors may be traversed with branch units.

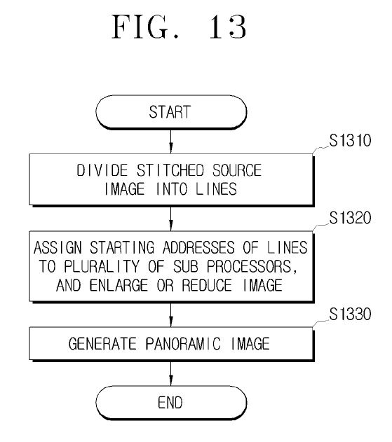

FIG. 12 is a flowchart of a process of stitching data according to an embodiment of the present invention. FIG. 12 shows the third operation of the sub processors, which may be performed after performing operation S1130 in FIG. 11. The source image is divided into a plurality of areas in operation S1210. Areas corresponding to key points are assigned to the plurality of sub processors, and the source coordinates corresponding to target coordinates on a panoramic image to be generated are calculated in operation S1220.

The source image of the calculated source coordinates is applied to the target coordinates, and the source image is divided into a plurality of areas in operation S1230. The divided source images are assigned to the plurality of sub processors, and the sub processors interpolate the source images in operation S1240, and the source images are stitched in operation S1250.

FIG. 13 is a flowchart of a process of blending images according to an exemplary embodiment of the present invention. FIG. 13 shows the fourth operation of the sub processors, which may be performed after performing operation S1250 in FIG. 12. The stitched source image is divided into lines in operation S1310. The starting addresses of the lines are assigned to the plurality of sub processors, and the image is enlarged or reduced in operation S1320, and thus a panoramic image is generated in operation S1330. Each operation is performed using the plurality of sub processors, and thus the operation time is reduced.

As described above, a panoramic image generating apparatus according to aspects of the present invention uses a plurality of processors to perform operations of a panoramic image process in parallel. Therefore, the time required to generate a panoramic image is reduced.

Aspects of the present invention can also be embodied as computer readable codes on a computer readable medium. The computer readable medium is any data storage device that can store data which can be thereafter read by a computer system. Examples of the computer readable medium also include read-only memory (ROM), random-access memory (RAM), CDs, DVDs, Blu-ray discs, magnetic tapes, floppy disks, and optical data storage devices. Aspects of the present invention may also be embodied as carrier waves (such as data transmission through the Internet). The computer readable medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of generating a panoramic image, comprising:
dividing data of an image to be processed to form the panoramic image into a plurality of areas;
assigning the divided data to a plurality of sub processors, and processing the data in parallel; and
combining the data processed by the sub processors so as to form the panoramic image.

2. The method according to claim 1, wherein the dividing of the data, the assigning and processing of the divided data, and the combining of the data are performed by each of a plurality of sub processors of a panoramic image processing apparatus.

3. The method according to claim 2, wherein the sub processors perform one of a first operation to extract key points from a plurality of source images, a second operation to match the extracted key points, a third operation to stitch the plurality of images using the matched key points, and a fourth operation to blend the stitched source images.

4. The method according to claim 3, wherein the first operation comprises:
dividing the source image into a plurality of areas;
assigning the divided source images to the plurality of sub processors, and blurring the source images;
dividing the blurred source images into a plurality of areas;
assigning the divided source images to the plurality of sub processors, and calculating the difference of Gaussians; and
extracting the key points using the calculated difference of Gaussians.

5. The method according to claim 3, wherein the second operation comprises:
building a search tree to search for and match the key points;
assigning the search tree to the plurality of sub processors, and traversing each branch unit of the search tree; and
matching the key points by traversing the search tree.

6. The method according to claim 3, wherein the third operation comprises:
dividing the source image into a plurality of areas;
assigning the areas corresponding to the key points to the plurality of sub processors and extracting source coordinates corresponding to target coordinates on the panoramic image to be generated;
applying a source image corresponding to the extracted source coordinates to the target coordinates, and dividing the source image;
assigning the divided source image to the plurality of sub processors, and interpolating the source image; and
generating the source image stitched by the interpolation.

7. The method according to claim 3, wherein the fourth operation comprises:
dividing the stitched source image into lines;
assigning starting addresses of the lines to the plurality of sub processors, and reducing or enlarging the stitched source image;
combining the reduced or enlarged source image, and generating a panoramic image.

8. The method of claim 1, wherein the divided data are assigned using round-robin scheduling.

9. A panoramic image generating apparatus, comprising:
a plurality of sub processors; and
a main processor to divide data of an image to be processed to form the panoramic image into a plurality of areas, to assign the divided data to the plurality of sub processors, and to process the data in parallel.

10. The apparatus of claim 9, wherein the main processor divides the data and assigns the data for each of at least one operation of a panoramic image process.

11. The apparatus of claim 10, wherein the at least one operation comprises at least one of a first operation to extract key points from a plurality of source images, a second operation to match the extracted key points, a third operation to stitch the plurality of images using the matched key points, and/or a fourth operation to blend the stitched source images.

12. The apparatus of claim 11, wherein, during the first operation:
the plurality of sub processors blur the source images;
the main processor divides the blurred source images into a plurality of areas and assigns the divided source images to the plurality of sub processors;
the plurality of sub processors calculate the difference of Gaussians and extract the key points based on the calculated difference of Gaussians.

13. The apparatus of claim 11, wherein, during the second operation:
the main processor builds a search tree to search for and match the key points and assigns the built search tree to the plurality of sub processors; and
the plurality of sub processors traverse each branch unit of the search tree and match the key points.

14. The apparatus of claim 11, wherein, during the third operation:
the main processor divides the source image into a plurality of areas, and assigns the areas corresponding to the key points to the plurality of sub processors;
the plurality of sub processors extract source coordinates corresponding to target coordinates on a panoramic image to be generated;
the main processor applies a source image corresponding to the extracted source coordinates to the target coordinates, divides the source image, and assigns the divided source image to the plurality of sub processors; and
the plurality of sub processors interpolate the source image and generate the source image stitched by the interpolation.

15. The apparatus of claim 11, wherein, during the fourth operation:
the main processor divides the stitched source image into lines, and assigns starting addresses of the lines to the plurality of sub processors;
the plurality of sub processors reduce or enlarge the stitched source image; and
the main processor combines the reduced or enlarged source image to generate the panoramic image.

16. The apparatus of claim 9, wherein the divided data are assigned using round-robin scheduling.
